(19) United States
(12) Patent Application Publication
(10) Pub. No.: US 2016/0106230 A1
(43) Pub. Date: Apr. 21, 2016

(54) MODEL AND METHOD FOR ATTACHING AN OBJECT TO A RAILING

(71) Applicant: Charbel Nassif, Sainte Eustache (CA)

(72) Inventor: Charbel Nassif, Sainte Eustache (CA)

(21) Appl. No.: 14/977,418

(22) Filed: Dec. 21, 2015

Related U.S. Application Data
(63) Continuation of application No. 13/604,616, filed on Sep. 5, 2012.

(51) Int. Cl. A47D 15/00; F16M 13/02

(52) U.S. Cl. CPC A47D 15/00; F16M 13/02

(57) ABSTRACT

A model and method for attaching an object to a railing is provided that serves to attach securely to a universal array of slats and spindles without causing damage thereto. The model and method has a clamp that is configured for attaching to the slats or spindles of a railing with jam plates that are covered by a non-abrasive material. A lightweight yet strong tubular body protrudes from the top of the clamp, and a strategically angled, lightweight and strong rod protrudes from the top of the tower. It is from the free end of the strategically angled rod that an object may be hung.

This application is a continuation of U.S. patent application Ser. No. 13/604,616, filed Sep. 5, 2012, entitled MODEL AND METHOD FOR ATTACHING AN OBJECT TO A RAILING, which is incorporated herein by reference.

The present invention relates to a model of attaching an item to the slats or spindles located on the side of a balustrade. More particularly, in its preferred use, the present invention relates to a model of attaching a decorative mobile to the slats or spindles of a child's crib.

### BACKGROUND OF THE INVENTION

Parents and caregivers naturally desire to provide a supportive and engaging environment in which their children can grow and flourish. The desire to provide a supportive and engaging environment begins prior to or at the birth of the child. For example, in preparing their home for the arrival of a child, parents and caregivers purchase and collect items that allow the child to eat, sleep, bathe, and play. An integral part of providing a supportive and engaging environment is introducing children to the vivid and beautiful colors and sounds of life.

In preparing their home for a child, most parents set up a crib in which to lay their child to sleep. Some of the time, the crib may be located in a nursery—a room or area in the home specifically designated as the place where the child sleeps and where his or her things are kept. The nursery is often decorated with the child's taste in mind, with bright colors and musical toys. In order to make the crib more conducive to stimulating the child's eyes and ears, many parents opt to attach a musical, colorful mobile to the child's crib.

The devices that serve to attach items to the slats or spindles on the sides of cribs that exist in the industry attach to the slats or spindles by coming into contact somehow with the top of the railing. These devices are comprised of a ledge of some sort that attaches to the top of the railing. This limits the area on the slats or spindles upon which a parent or caregiver can attach the device. For example, a parent or caregiver may not be able to attach the device in the corner of the crib or other desired spot because of the length of the ledge.

Further, the devices that exist in the industry are made of a hard plastic, metal, or other material that, when attached to the railing or slats of a child's crib, cause unsightly scratches, cuts and other damage to the surface of the crib. If the crib mobile's device for attachment somehow damages the surface of the railing or slats by scratching or cutting into them, it can take away from the beauty and the value of the crib itself.

Moreover, it is often the case that the attachment devices that exist in the industry are not made to attach to a universal array of railing and slat sizes on cribs. This causes various problems with the integrity of the attachment of the item to the crib. These problems include, but are not limited to, the crib mobile's attaching incorrectly or damaging the surface of the crib's railing or slats. If the crib mobile attaches crookedly or insecurely, it is potentially dangerous, as it could fall into the crib where the baby is lying. If the crib mobile falls into the crib, it can potentially injure the child.

As noted above, the devices that exist in the industry are limited in terms of the models of cribs to which they are able to attach. The devices are not made in such a way that they can attach to a universal array of cribs, regardless of the length and thickness of the railing or slats.

For example, there are types of cribs that are especially bulky with thick rails and slats upon which such models cannot properly fit, thereby exacerbating the problem of an insecure or crooked attachment, or the problem of the crib mobile's scratching the surface of the crib.

Hence, in light of the aforementioned, there is a need for an improved device which, by virtue of its design and components, would be able to overcome or at least minimize some of the aforementioned problems with prior art. The industry needs a model and method by which a crib mobile can attach to the side of any crib securely and without causing damage to the surface of the crib.

### SUMMARY OF THE INVENTION

In a first aspect, the present invention discloses a model for attaching an object to the slats or spindles of a railing or balustrade, comprising: an elongated attachment member elongated along a vertical axis having a lower portion which is positioned in between the two adjacent slats or spindles; a retaining member further comprised of a rear portion and a threaded shaft protruding therefrom to be inserted into an aperture of the lower portion of the elongated retaining member to retain the model in between two adjacent slats; a fastening member comprised of an internally-threaded opening for threaded engagement with the threaded shaft of the retaining member; and a curved rod further comprised of a securing member to be inserted within a hole of the elongated attachment member and an affixing portion from which an attachment may be hung; wherein the two adjacent slats or spindles are firmly secured between the rear portion of the retaining member and the lower portion of the elongated attachment member.

### BRIEF DESCRIPTION OF THE DRAWINGS

FIG. 1 is a top view of a model to attach an object to a railing in a disassembled configuration, according to a preferred embodiment of the present invention;

FIG. 1a is a top view of a rear portion of the retaining member of the model to attach an object to a railing in a disassembled configuration, according to a preferred embodiment of the present invention;

FIG. 2 is a side cross-sectional view of the model to attach an object to a railing in a disassembled configuration, according to a preferred embodiment of the present invention;

FIG. 3 is a front view of a curved rod of the model to attach an object to a railing, according to a preferred embodiment of the present invention; and

FIG. 4 is a side view of a curved rod of the model to attach an object to a railing, according to a preferred embodiment of the present invention.

FIG. 5 is a side view of the model to attach an object to a railing in a disassembled configuration with an attached curved rod, according to a preferred embodiment of the present invention;

FIG. 6 is a rear view of the model to attach an object to a railing without an end cap and with an attached curved rod in a disassembled configuration, according to a preferred embodiment of the present invention.

### DETAILED DESCRIPTION OF THE INVENTION

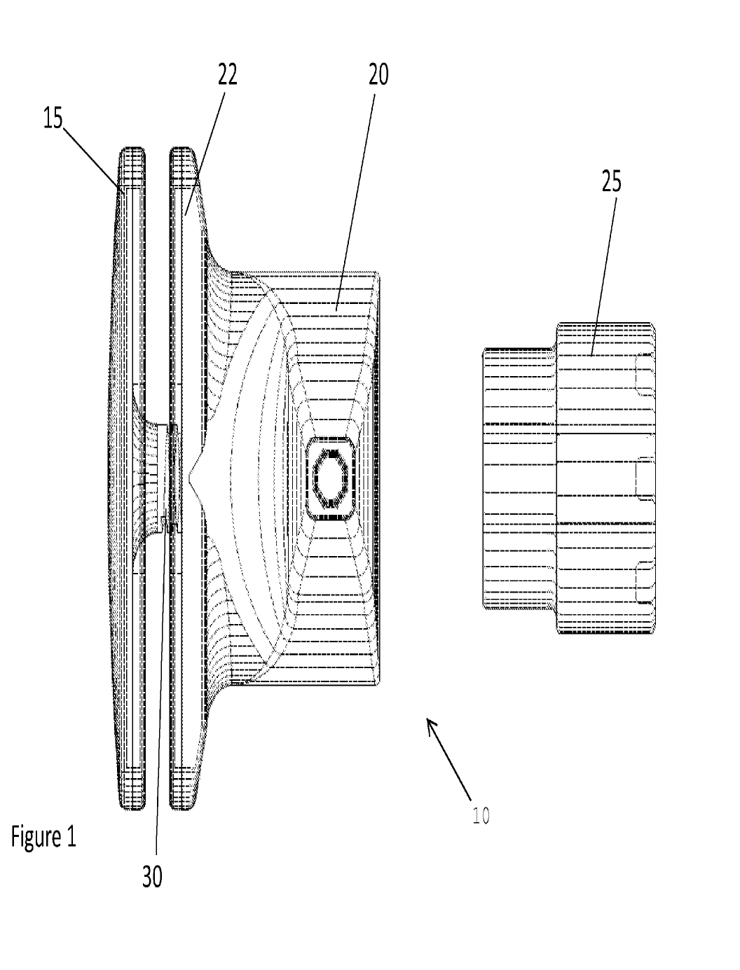

With reference to FIG. 1 the model to attach an object to a railing 10 is shown in a disassembled configuration. The model 10 is generally comprised of a retaining member 15, an elongated attachment member 20 and a fastening member 25. The model 10 is positioned and secured in between adjacent slats on an infant's crib and a curved rod (not shown) is affixed onto the elongated attachment member 20 in order to allow for the suspension of a toy or other similar object. In order to fasten the model 10 onto a crib in between two adjacent slats, a lower portion 22 of the elongated attachment member 20, which is elongated in the vertical axis, is positioned in between two adjacent slats. The retaining member 15 is then inserted into the lower portion 22 of the elongated attachment member 20 by threading said retaining member 15 into the fastening member 25, said fastening member 25 partially inserted within the lower portion 22 of the elongated attachment member 20. The retaining member 15 is comprised of a threaded shaft 30 which threads into an internally-threaded opening (not shown) of the fastening member 25. The lower portion 22 of the elongated attachment member 20 is hollow in order to allow for both the threaded shaft 30 of the retaining member 15 and the threaded opening (not shown) of the fastening member 25 to connect within. Once the width of the slats corresponds to the space in between the retaining member 15 and the lower portion 22 of the elongated attachment member 20, the model 10 is secured.

With reference to Figure la, the threaded shaft 30 is shown protruding from a rear portion 32 of the retaining member 15. It is said threaded shaft 30 that will connect into the threaded opening (not shown) of the fastening member (not shown). The rear portion 32 is comprised of a non-abrasive material in order to reduce damage to the crib's slats.

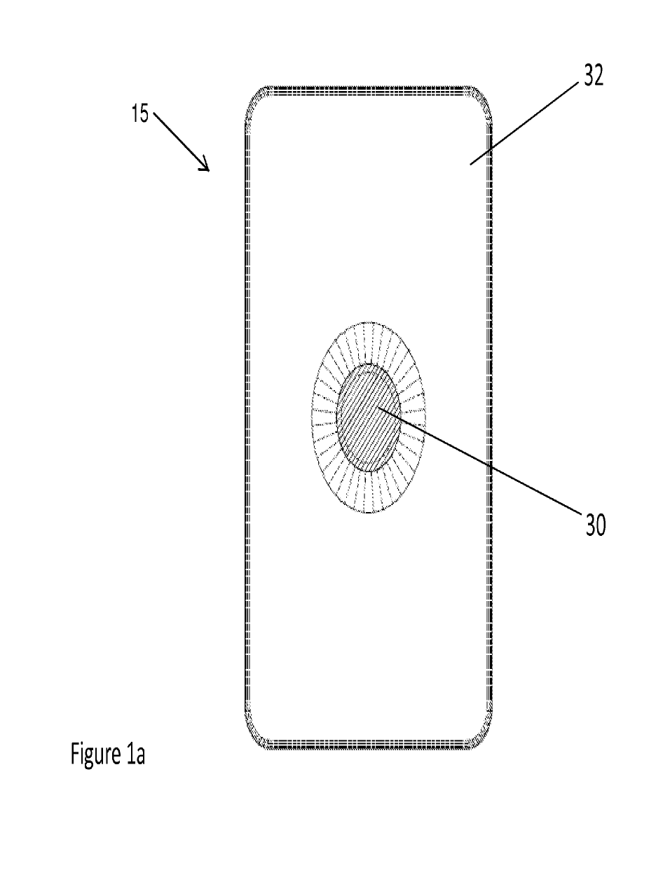

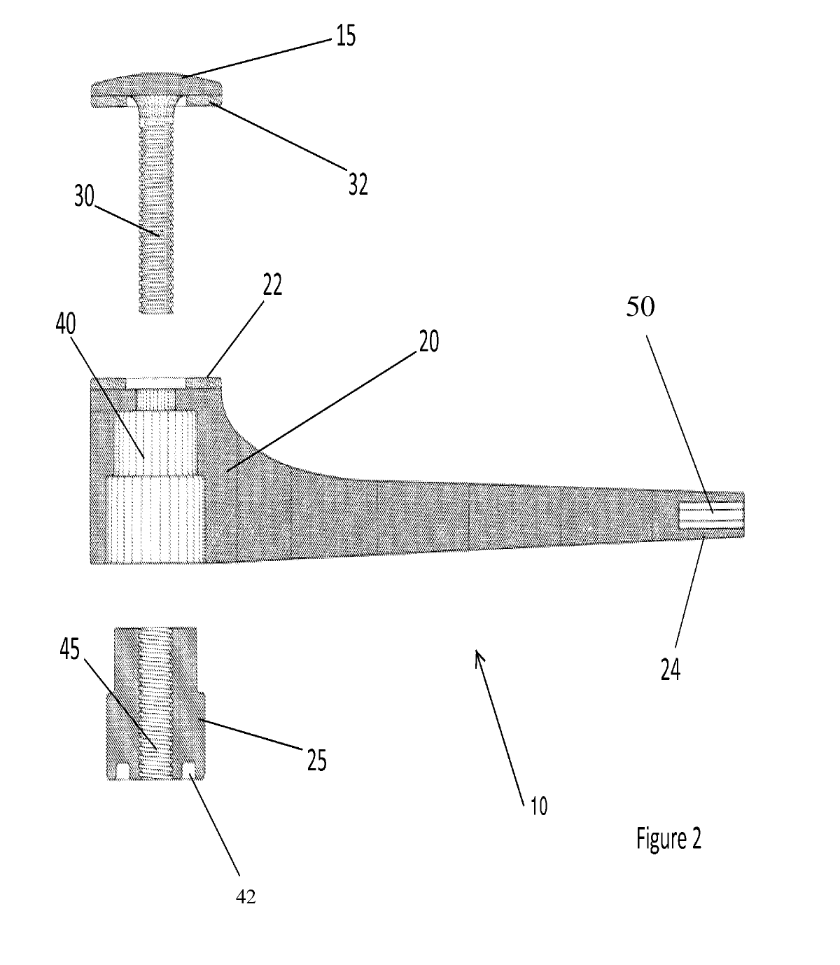

With reference to FIG. 2, the model 10 is shown in a cross-sectional view. As such, the threaded shaft 30 of the retaining member 15 is shown about to be inserted into an aperture 40 of the lower section 22 of the elongated attachment member 20. The lower section 22 of the elongated attachment member 20 is also comprised of the non-abrasive material that was mentioned previously, such that slats are trapped in between two section of non-abrasive material and therefore there is less damage and wear to the slats. Meanwhile, the fastening member 25 is comprised of an internally-threaded opening 45 which will engage said threaded shaft 30 to secure the retaining member 15 to the elongated attachment member 20 and thus to the aforementioned slats. The elongated attachment member 20 is further comprised of an upper portion 24 which has a hole 50 in order to receive a curved rod (not shown). It is shown through FIG. 2 that the aperture 40 is substantially the same shape so as to match the shape of the fastening member 25 and allow a better connection therein. Said fastening member 25 is further comprised of a notch 42, again which is clearly visible in FIG. 2, so as to allow a user to insert his or her fingers and thread the fastening member 25 into the retaining member 15.

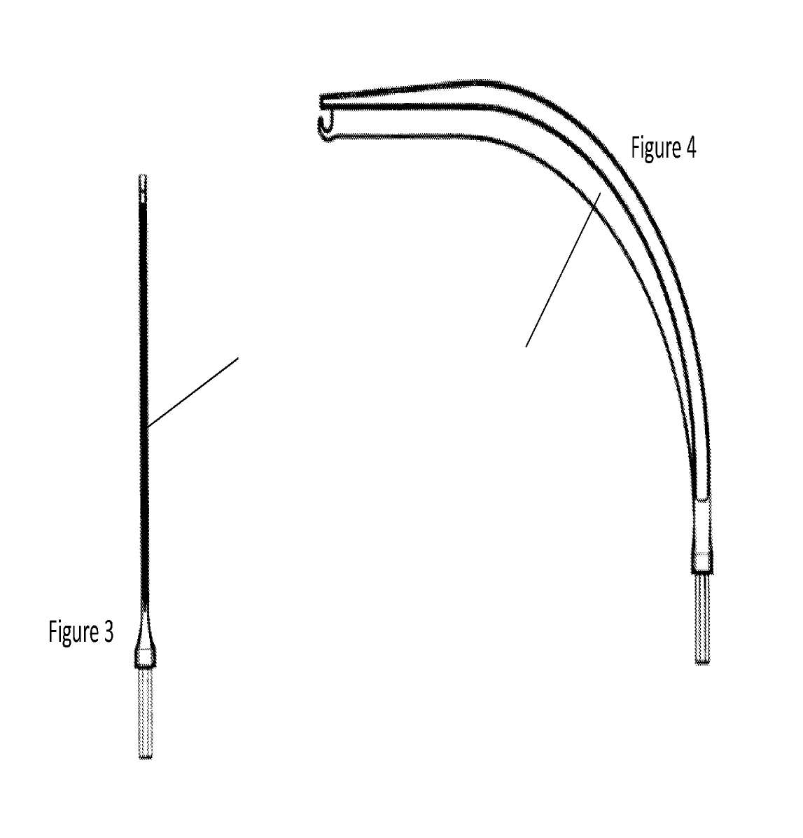

With reference to FIGS. 3 and 4, the curved rod 55 is shown. The curved rod 55 is comprised of a securing member 60 which serves to be inserted within the hole (not shown) of the elongated attachment member 20. The elongated attachment member 20 is further comprised of an affixing portion 65 on an upper end thereof in order to affix or suspend a child's toy or other similar object. Indeed, once the model (not shown) is attached to a crib, a parent or caregiver can attach a toy or other device in order to entertain the child during sleep or another crib-related activity. It is evident that the curved rod 55 will need to be positioned such that the curved section hangs over the child.

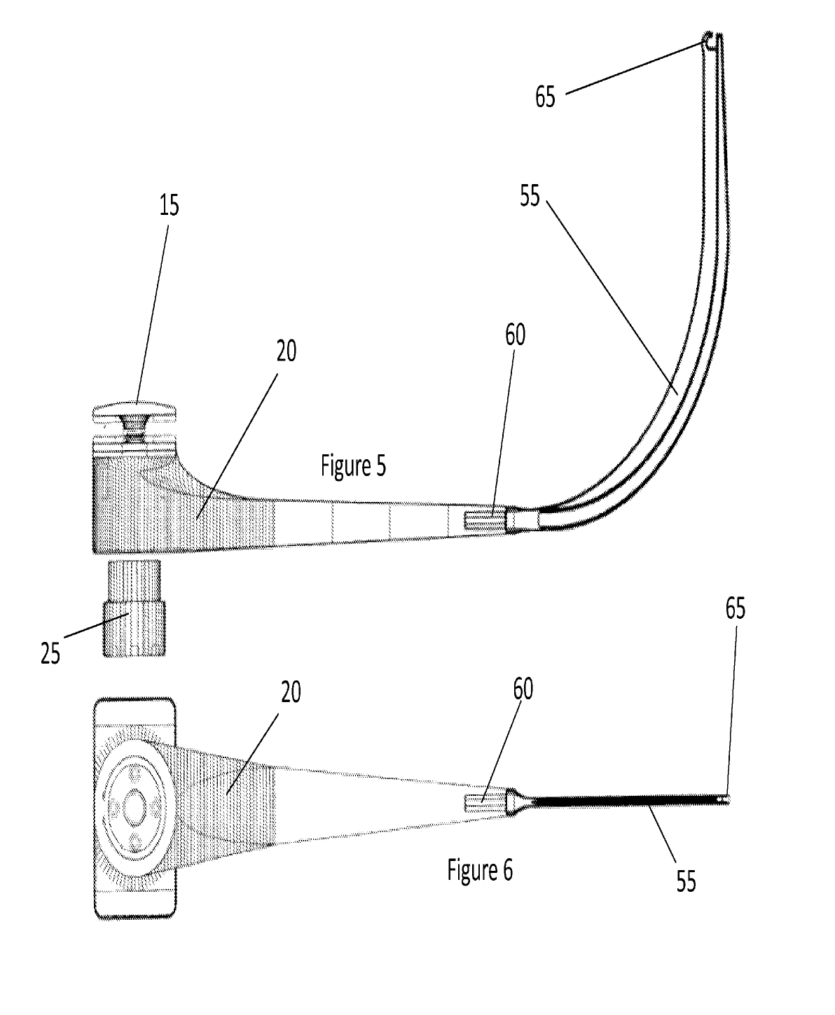

With reference to FIGS. 5 and 6, the model 10 is shown with the securing member 60 of the curved rod 55 secured within the hole (not shown) of the elongated attachment member 20. Therefore, the model 10 is in a quasi-assembled state, whereby it simply needs to be secured in between adjacent slats of a crib by the means described above; that is to say by securing the retaining member 15 within an aperture of the elongated attachment means 20 and threading onto a threaded opening (not shown) of the fastening member 25.

It is to be understood that the model 10 is meant to be attached to adjacent slats or spindles and not the top edge of the railing of the crib which is done in traditional systems. Indeed, this serves to preserve the condition of the crib by preventing scratches or cuts to the top of the railing that would otherwise be caused by such a ledge.

Of course, numerous modifications could be made to the above-described embodiments without departing from the scope of the invention, as apparent to a person skilled in the art.

Moreover, although the present invention was primarily designed for a child's crib, or for use with a colorful and musical mobile, it is understood that it may be used to attach other items or objects to slats or spindles that are not a part of a child's crib, but rather a different railing, as apparent to a person skilled in the art. For this reason, expressions such as “child,” “crib,” etc., as used herein should not be taken as to limit the scope of the present invention and includes all other kinds of items, objects, and/or purposes with which the present invention could be used and may be useful. Moreover, in the context of the present invention, the expressions “infant” and “child” can be used interchangeably. Moreover, in the context of the present invention, the expressions “slat” and “spindle” can be used interchangeably. Moreover, in the context of the present invention, the expressions “parent” and “caregiver” can be used interchangeably. Moreover, in the context of the present invention, the expressions “angled” and “curved” can be used interchangeably.

In addition, although the preferred embodiment of the present invention as illustrated in the accompanying drawings comprises various components and although the preferred embodiment of the support as shown consists of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperation thereinbetween, as well as other suitable geometrical configurations may be used for the device, and corresponding parts, according to the present invention, as briefly explained and as can be easily inferred herefrom by a person skilled in the art, without departing from the scope of the invention.

Having thus described the invention, it is now claimed:

I/we claim:

1. A crib support device for supporting an associated toy or the like to an associated crib, the associated crib having a generally vertical outer boundary defining an inside on one side of the boundary and an outside on an opposite side of the boundary, wherein the inside comprises a child reception area, the generally vertical outer boundary defined, at least in part, by a crib railing positioned above and attach to a plurality of crib slats, the crib support device comprising:
an attachment member having a first end and a second end;
a support device having a first end that is attachable to the second end of the attachment member and a second end that is attachable to the associated toy or the like;
a fastener apparatus that is operable to fasten the first end of the attachment member to the associated plurality of crib slats; and,
wherein when the attachment member is properly fastened to the crib slats by the fastener apparatus and the support device is properly attached to the attachment member: (1) the attachment member extends generally vertically upward on the outside of the boundary from its first end to its second end; (2) the support device supports the associated toy or the like on the inside of the boundary; and, (3) no portion of the crib support device contacts the crib railing.

2. The crib support device of claim 1 wherein:
the second end of the attachment member comprises an aperture;
the fastener apparatus comprises: a retaining member comprising a threaded shaft; and, a fastening member comprising a threading opening; and,
the threaded shaft is inserted between two adjacent crib slats, through the aperture and received in the threaded opening to fasten the first end of the attachment member to the associated plurality of crib slats.

3. The crib support device of claim 2 wherein a portion of the fastening member is received within the aperture when the first end of the attachment member is fastened to the associated plurality of crib slats.

4. The crib support device of claim 2 wherein the fastening member comprises a notch suitable for use by a user to grip the fastening member when threading the retaining member to the fastening member.

5. The crib support device of claim 1 wherein when the attachment member is properly fastened to the crib slats by the fastener apparatus and the support device is properly attached to the attachment member:
the first end of the support device is positioned on the outside of the boundary; and,
the second end of the support device is positioned on the inside of the boundary.

6. The crib support device of claim 1 wherein the attachment member is curved along its length.

7. The crib support device of claim 1 wherein when the attachment member is properly fastened to the crib slats by the fastener apparatus:
a portion of the attachment member is inserted between two adjacent crib slats.

8. The crib support device of claim 1 wherein portions of the crib support device that contact the crib slats are formed of a non-abrasive material.
